(19) United States
(12) Patent Application Publication
(10) Pub. No.: US 2016/0374175 A1
(43) Pub. Date: Dec. 22, 2016

(54) APPARATUS AND METHOD FOR CONTROLLING REFRIGERATOR ACCORDING TO SURROUNDING BRIGHTNESS

(71) Applicant: Dongbu Daewoo Electronics Corporation, Seoul (KR)

(72) Inventor: Kwan Seo KOO, Seoul (KR)

(21) Appl. No.: 14/879,029

(22) Filed: Oct. 8, 2015

(30) Foreign Application Priority Data
Jun. 18, 2015 (KR) 10-2015-0086866

(51) Int. Cl. H05B 37/02; F25D 29/00; F25D 27/00

(52) U.S. Cl. CPC H05B 37/0218; H05B 37/0227; F25D 27/005; F25D 29/00

(57) ABSTRACT

A refrigerator providing automatically adjustable inside illumination and compressor operation speed. An optical sensing unit is used to sense the ambient light brightness proximate to the refrigerator. The brightness of the inside lamps are adjusted based on the sensed ambient light brightness so as to prevent glare to a user who opens the refrigerator in the dark. The sensed ambient light brightness is also used to control the operation speed of the compressor. If the ambient lighting condition indicates it is night time, the compressor can run at a reduced speed and so produce less operation noise.

### CROSS-REFERENCE TO RELATED APPLICATIONS

This application claims priority to Korean Patent Application No. 10-2015-0086866, filed on Jun. 18, 2015, the disclosure of which is herein incorporated by reference in its entirety for all purposes.

### FIELD OF THE INVENTION

The present invention relates to refrigerators, and more specifically, to controlling mechanisms of internal light sources and compressors inside the refrigerators.

### BACKGROUND OF THE INVENTION

A refrigerator usually has an inside lamp which turns on when the refrigerator opens. It helps a user to see the inside of the refrigerator.

In a conventional refrigerator, the brightness of an inside lamp is a fixed value regardless of the lighting condition around the refrigerator, which normally is not an issue if the surrounding area is bright.

However, when opening a refrigerator in dark, a user's eyes may feel uncomfortable when encountering the strong brightness of the inside lamps.

The ambient light surrounding the refrigerator may vary with time, e.g., is low at night.

Moreover, at night, because background noise level is relatively low, noise from the operation of a refrigerator compressor can become pronounced and disturbing to a user.

### SUMMARY OF THE INVENTION

Therefore, it would be advantageous to provide a mechanism to adjust brightness of a refrigerator's inside lamp to reduce glare to a user.

It would be advantageous to provide a refrigerator capable of reducing driving noise of the compressor at night.

According to one embodiment of the present disclosure, a refrigerator includes: an optical sensing unit configured to sense ambient brightness proximate to the refrigerator; a controller configured to determine an illumination intensity control signal to control the illumination inside of the refrigerator based on the ambient light brightness and to determine a driving speed control signal to control a driving speed of the compressor based on the brightness and a closed state time of the door; and an adjustment unit configured to adjust the illumination intensity based on the illumination intensity control signal and to adjust the driving speed of the compressor based on the driving speed control signal, and the closed state time of the door as sensed by the controller.

Further, the brightness is classified into any one of a plurality of predetermined categories based on at least one predetermined boundary value. Different illumination intensity control signals may be assigned to the respective categories. The controller may determine the illumination intensity control signal based on an assigned category. For example, a power-saving category corresponds to the lowest ambient light brightness.

Further, the illumination intensity determined based on the illumination intensity control signal is a predetermined value.

Further, the controller senses opening and closing of the door of the refrigerator. The illumination intensity control signal is determined based on the sensed brightness sensed by the optical sensing unit when the controller senses opening of the door.

Further, the illumination intensity of the inside of the refrigerator is provided by a plurality of inside lamps installed within the refrigerator. The adjustment unit can adjust the illumination intensity by selectively turning on at least one of the inside lamps or controlling brightness of the inside lamps based on the illumination intensity control signal.

Further, the adjustment unit can gradually increase the illumination intensity from a predetermined starting value to a value based on the illumination intensity control signal, when the door is opened.

Further, the controller can sense whether or not the closed state time of the door exceeds a predetermined power-saving time. If the closed state time of the door exceeds the predetermined power-saving time and the brightness is classified into a predetermined power-saving section, the controller can determine a driving speed control signal to drive the compressor at a power-saving driving speed lower than a predetermined normal driving speed.

Another embodiment of the present invention provides a method for controlling a refrigerator includes: sensing ambient light brightness proximate to the refrigerator;

sensing a closed state time of a door provided on the refrigerator; generating a driving speed control signal to control a driving speed of a compressor installed in the refrigerator based on the brightness and the closed state time of the door; adjusting the driving speed based on the driving speed control signal; generating an illumination intensity control signal to control an illumination intensity of the inside of the refrigerator based on the brightness; and adjusting the illumination intensity based on the illumination intensity control signal.

Further, the brightness is classified into any one of a plurality of predetermined categories based on at least one predetermined boundary value and different illumination intensity control signals are assigned to the respective categories. In the determination of the illumination intensity control signal, the illumination intensity control signal assigned to the classified section is determined.

Further, the illumination intensity based on the illumination intensity control signal, assigned to a power-saving category defined as a category having the lowest brightness among the predetermined sections, is an illumination intensity of a predetermined rate.

Further, the determination of the illumination intensity control signal includes: sensing opening and closing of the door of the refrigerator; and determining the illumination intensity control signal based on the brightness when opening of the door is sensed.

Further, the illumination intensity of the inside of the refrigerator is provided by a plurality of inside lamps installed within the refrigerator; and in the adjustment of the illumination intensity, the illumination intensity is adjusted by selectively turning on at least one of the inside lamps or controlling brightness of the inside lamps based on the illumination intensity control signal.

Further, in the adjustment of the illumination intensity, the illumination intensity is gradually increased from a predetermined starting value to a value based on the illumination intensity control signal, when the door is opened.

Further, the determination of the driving speed control signal includes: sensing whether the closed state time of the door exceeds a predetermined power-saving time; and determining a driving speed control signal to drive the compressor at a power-saving driving speed lower than a predetermined normal driving speed, if the closed state time of the door exceeds the predetermined power-saving time and the brightness is classified into a predetermined power-saving section.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 is a function block diagram illustrating the configuration of an apparatus for controlling a refrigerator in accordance with one embodiment of the present invention;

FIG. 2 is a flowchart illustrating an exemplary method of controlling a refrigerator in accordance with one embodiment of the present invention;

FIG. 3 is illustrates an exemplary process for controlling a refrigerator in accordance with one embodiment of the present invention;

FIG. 4 is a flowchart illustrating an exemplary method of controlling a refrigerator in accordance with another embodiment of the present invention; and

FIG. 5 is a flow chart illustrating an exemplary process for controlling a refrigerator in accordance with another embodiment of the present invention.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

A ‘refrigerator’ herein refers to an appliance that can provide cool air to maintain a storage space inside the appliance a low temperature. A refrigerator may refer to one of a refrigerator with a refrigerating room only, a freezer and an apparatus having a combination of a refrigerating room and a freezer. Further, it will be understood that a apparatus for controlling a refrigerator in accordance with one embodiment of the present invention is mounted on such a ‘refrigerator’ and a method for controlling a refrigerator in accordance with one embodiment of the present invention is a method executed by such an apparatus.

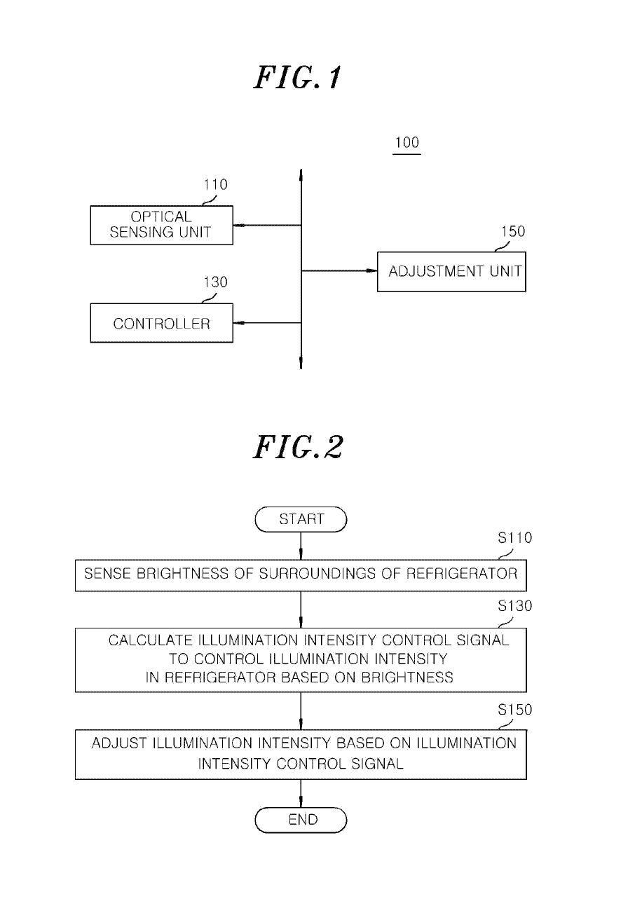

FIG. 1 is a function block diagram illustrating the configuration of an apparatus for controlling a refrigerator in accordance with one embodiment of the present invention.

With reference to FIG. 1, an apparatus 100 for controlling a refrigerator includes an optical sensing unit 110, a controller 130 and an adjustment unit 150. However, such a configuration of the apparatus 100 is merely exemplary and the apparatus 100 may exclude at least one of these components or further include other components in addition to these components.

The optical sensing unit 110 senses the ambient light proximate the refrigerator and may be, for example, an optical sensor.

For example, the optical sensing unit 110 may be mounted in a liquid crystal display (LCD) disposed on the front surface of the refrigerator. The LCD can display a state of the refrigerator. The optical sensing unit may also be mounted at the upper end or in the middle of the front surface or a side surface of the refrigerator, or any other position suitable for sensing ambient light.

For example, the controller 130 may be a micro-controller unit (MCU) including a microprocessor and store instructions for executing a process as described below.

The controller 130 can generate a control signal to control the internal illumination in the refrigerator based on the ambient light sensed by the optical sensing unit 110. More specifically, the controller 130 may store predetermined boundary values that classify brightness into a plurality of brightness sections (or categories). Here, the predetermined boundary values are reference values to classify brightness, e.g., by lx (the unit of luminance). The illumination intensity control signals are used to adjust the illumination intensity in the refrigerator by selectively turning on one or more inside lamps installed in the refrigerator. The control signals may also control the brightness of the inside lamps by controlling the electrical current or other suitable mechanism. Further, the boundary values and illumination intensity control signals may be configured by a user through a user interface unit mounted on the refrigerator, which is not shown in FIG. 1.

For example, regarding the ambient light brightness categories, a first category may represent night without or with minimal illumination, a second category may represent evening with illumination, and a third category may represent day. For instance, the first category may be in the range of 1.5-5 lx, the second category may be in the range of 5-10 lx, and the third category may be in the range of 10-16 lx. Further, 50% of the maximum current value may be assigned to the first category, 70% of the maximum current value may be assigned to the second category, and the maximum current value may be assigned to the third category.

Here, the first category may be referred to as a power-saving category. The illumination intensity control signal assigned to the power-saving category may be a value derived from experimentation so as to provide an illumination intensity not causing glare to the user.

The illumination intensity control signal may be determined based on ambient light when the door of the refrigerator is opened. For this purpose, the controller 130 may sense opening and closing of the door, receive a brightness signal from the optical sensing unit 110 when opening of the door of the refrigerator is sensed, and determine the illumination intensity control signal.

However, the disclosure is not limited to determination of the illumination intensity control signal based on current ambient light when the door of the refrigerator opens. That is, the illumination intensity control signal may be determined based on the ambient light brightness sensed during a predetermined time interval before the door of the refrigerator opens or just before the door of the refrigerator opens.

The adjustment unit 150 may adjust an illumination intensity based on the illumination intensity control signal determined by the controller 130. The inside lamps provide adjustable illumination as controlled by the adjustment unit 150. Here, the adjustment unit 150 may adjust the illumination intensity by selectively turning on one or more inside lamps based on the illumination intensity control signal. For example, the adjustment unit 150 may turn on only one inside lamp based on the illumination intensity control signal representing 50% of the maximum current value in the first category; turn on two inside lamps based on the illumination intensity control signal representing 70% of the maximum current value in the second category; and turn on all inside lamps based on the illumination intensity control signal representing the maximum current value in the third category.

Selectively turning-on of the inside lamps is exemplary and the disclosure is not limited thereto. That is, according to embodiments, the adjustment unit 150 may control the illumination intensity by controlling brightness of the individual inside lamps. In this case, the adjustment unit 150 may adjust the inside lamps to output 50% of the maximum brightness in the first category, 70% of the maximum brightness in the second category, and 100% of the maximum brightness in the third category.

Therefore, if the ambient brightness is in the power-saving category (first category), the adjustment unit 150 may provide an illumination intensity which does not surprise a user when the user opens the refrigerator.

The adjustment unit 150 may gradually increase the illumination intensity from a predetermined starting value to another value based on the illumination intensity control signal received when the door of the refrigerator is opened. That is, the adjustment unit 150 may provide brightness of a predetermined starting value, e.g., the minimum brightness for a user to recognize objects at the moment when the door is opened, and then gradually increase brightness up to the illumination intensity indicated by the illumination intensity control signal.

Therefore, by gradually increasing brightness from a low value, the user's eyes may gradually adapt to brightness of the inside lamps and, thereby, glare may be advantageously avoided.

As described above, an apparatus for controlling a refrigerator in accordance with an embodiment of the present invention can adjust brightness of the inside lamps according to the ambient light surrounding the refrigerator, thus reducing glare due to the inside lamps even at night.

FIG. 2 is a flowchart illustrating an exemplary method of controlling a refrigerator in accordance with one embodiment of the present invention. The method shown in FIG. 2 may be executed by the apparatus shown in FIG. 1.

With reference to FIG. 2, the method may include sensing the ambient light brightness proximate to the refrigerator (at S110), determining an illumination intensity control signal to control an illumination intensity of the inside of the refrigerator based on the sensed brightness (at S130), and adjusting the illumination intensity based on the illumination intensity control signal (at S150). However, these operations are merely exemplary and the method may exclude at least one of the operations or further include other operations in addition to the operations.

Referring to FIGS. 1-3. First, the optical sensing unit 110 senses ambient light brightness near the refrigerator (at S110).

Further, the controller 130 senses opening of the door of the refrigerator (at S111) and receives the brightness value transmitted from the optical sensing unit 110 if opening of the door is sensed (at S112). As described above, the brightness may be sensed at the same time when opening of the door is sensed.

The controller 130 may include information regarding the predetermined values that classify the brightness into one of a plurality of predetermined categories and information regarding illumination intensity control signals assigned to the respective categories. Therefore, the controller 130 classifies the brightness value received from the optical sensing unit 110 into a category based on these predetermined values (at S113).

Thereafter, the controller 130 generates an illumination intensity control signal based on the brightness category (at S130) and transmits the illumination intensity control signal to the adjustment unit 150 (at S131).

Here, if the ambient light brightness is classified as a power-saving category indicating night or dark, the controller 130 may determine an illumination intensity control signal that can lead to reduced glare, e.g., at a low value.

The controller 150 adjusts the illumination intensity based on the illumination intensity control signal determined by the controller 130 (at S150). The inside lamps installed in the refrigerator provide the illumination intensity in the refrigerator and the illumination intensity provided by the inside lamps is adjusted by the adjustment unit 150. Here, the adjustment unit 150 may adjust the illumination intensity by selectively turning on at least one of the inside lamps based on the illumination intensity control signal. Alternatively, the adjustment unit 150 may control the illumination intensity by controlling brightness of the inside lamps based on the illumination intensity control signal.

If the brightness is classified in the power-saving category, the adjustment unit 150 may provide an illumination intensity which does not surprise a user when the user looks inside the refrigerator.

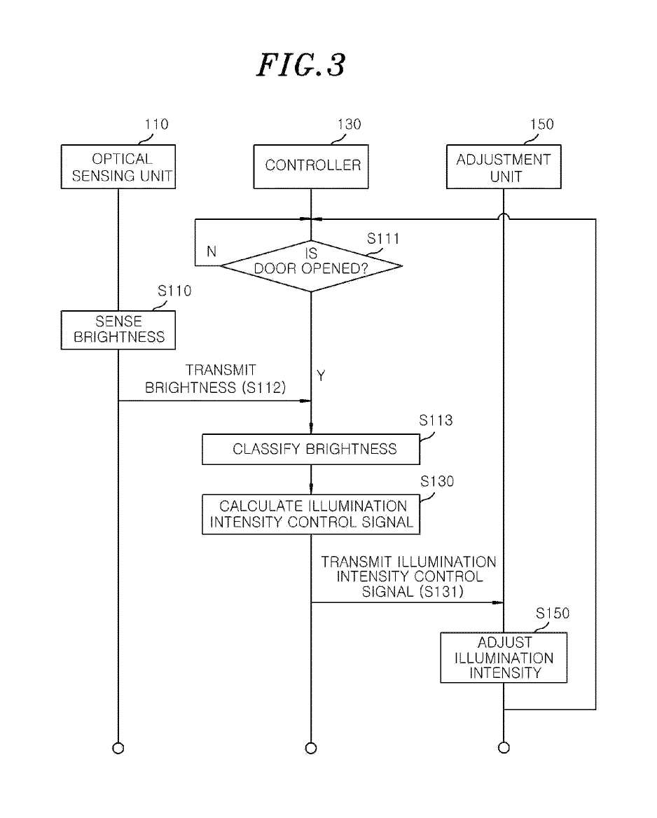

Further, although not shown in FIG. 3, the adjustment unit 150 may gradually increase the illumination intensity from a predetermined starting value to another value that is determined based on the illumination intensity control signal, when the door of the refrigerator is opened. That is, the adjustment unit 150 may provide brightness of the predetermined starting value, e.g., the minimum brightness to recognize objects at the moment when the door is opened, and then gradually increase the brightness, up over time to the illumination intensity indicated by the illumination intensity control signal.

Therefore, by gradually increasing brightness inside the refrigerator from a small value, a user can adapt their eyes to the brightness inside the refrigerator without glare.

As described above, a method for controlling a refrigerator in accordance with one embodiment of the present invention may include adjusting brightness of inside lamps according to a ambient light brightness around the refrigerator, thus reducing glare due to the inside lamps even at night.

### Control Apparatus

An apparatus for controlling a refrigerator in accordance with another embodiment of the present invention is described as follows. The apparatus in accordance with this embodiment has the same configuration as the first embodiment described above.

Referring to FIG. 1. The apparatus includes an optical sensing unit 110, a controller 130 and an adjustment unit 150. However, such a configuration of the apparatus is merely exemplary and the apparatus may exclude at least one of these elements or further include other elements in addition to these elements.

The optical sensing unit 110 in accordance with this embodiment is the same as the optical sensing unit 110 in accordance with the first embodiment and a detailed description thereof will thus be omitted.

The controller 130 in accordance with this embodiment determines an illumination intensity control signal to control an illumination intensity inside the refrigerator based on the ambient light sensed by the optical sensing unit 110. The adjustment unit 150 in accordance with this embodiment adjusts the illumination intensity based on the illumination intensity control signal. The Operations of the controller 130 and the adjustment unit 150 in accordance with this embodiment are the same as those in accordance with the previous-described embodiment and a detailed description thereof is omitted.

Additionally, the controller 130 may sense a closed state time of a refrigerator door and determine a driving speed control signal to control the driving speed of a compressor based on the brightness sensed by the optical sensing unit 110 as well as the sensed closed state time of the door. Here, the closed state time of the door in one embodiment means the duration in which the door remains closed since being opened last time.

More specifically, the controller 130 senses whether or not the closed state time of the door exceeds a predetermined power-saving time, and the predetermined power-saving time may have different values according to the ambient light brightness sensed by the optical sensing unit 110. For example, the power-saving time may be relatively long if the ambient brightness is low and be relatively short if the brightness is high. Further, in this embodiment, if the brightness is classified into the power-saving category, the power-saving time may be 4 hours but is not limited thereto.

If the closed state time of the door exceeds the above-described power-saving time and the brightness is classified into the power-saving category, the controller 130 may determine a driving speed control signal to drive the compressor installed in the refrigerator at a power-saving driving speed lower than a normal driving speed. The adjustment unit 150 may adjust the driving speed of the compressor based on the driving speed control signal. Here, the power-saving time and the power-saving driving speed may be configured by a user through the user interface unit mounted on the refrigerator, which is not shown in FIG. 1.

Therefore, in accordance with this embodiment of the present invention, the driving speed of the compressor may be lowered at night as indicated by low ambient brightness and. As a result, operation noise and power consumption of the refrigerator can be advantageously reduced.

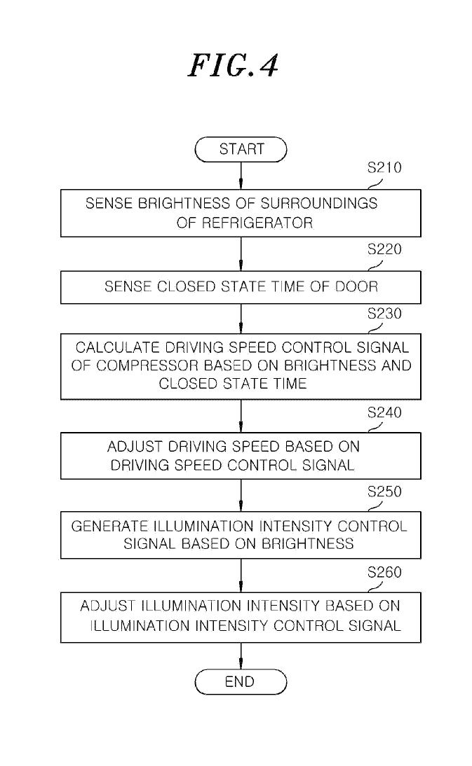

FIG. 4 is a flowchart illustrating an exemplary method of controlling a refrigerator in accordance with another embodiment of the present invention. The method in accordance with this embodiment may be executed by the apparatus as described with reference to FIGS. 1 and 3.

With reference to FIG. 4, the method may include: sensing a ambient light brightness surrounding the refrigerator (at S210); sensing a closed state time of a refrigerator door (at S220); determining a driving speed control signal based on the sensed brightness and the closed state time of the door (at S230); adjusting the driving speed of the compressor based on the driving speed control signal (at S240); determining an illumination intensity control signal to control an illumination intensity inside the refrigerator based on the sensed brightness (at S250); and adjusting the inside illumination intensity based on the illumination intensity control signal (at S260). However, these operations are merely exemplary and the method may exclude at least one of the operations or further include other operations in addition to the operations.

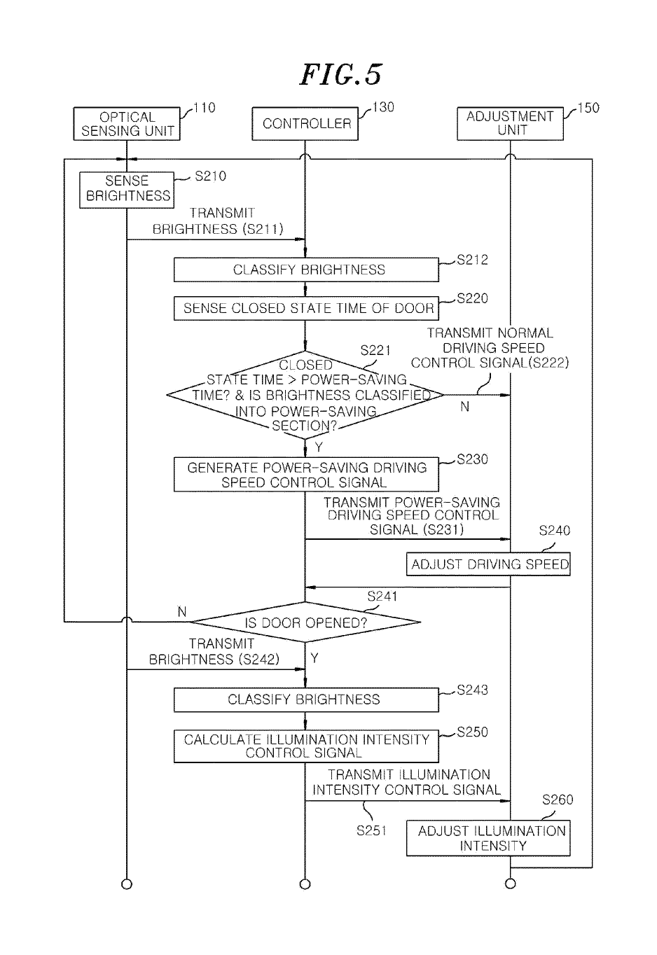

FIG. 5 illustrates an exemplary process of controlling a refrigerator in accordance with another embodiment of the present invention. Referring to FIGS. 1 4 and 5, the optical sensing unit 110 senses the ambient light brightness surrounding the refrigerator (at S210) and transmits a signal representing the sensed brightness to the controller 130 (at S211).

The controller 130 may store information regarding the predetermined values to classify the sensed brightness into one of a plurality of predetermined categories and illumination intensity control signals assigned to the respective categories. Therefore, the controller 130 classifies the brightness sensed by the optical sensing unit 110 into a category according to these predetermined values (at S212).

Thereafter, the controller 130 senses a closed state time of the door (at S220). If the brightness is in the predetermined power-saving category and the closed state time of the door exceeds the predetermined power-saving time, the controller 130 generates a power-saving driving speed control signal (at S230) and transmits the power-saving driving speed control signal to the adjustment unit 150 (at S231). Otherwise, the controller 130 generates a normal driving speed control signal and transmits the normal driving speed control signal to the adjustment unit 150 (at S222).

The adjustment unit 150 adjusts the driving speed of the compressor based on the received driving speed control signal (at S240).

Therefore, in accordance with this embodiment of the present invention, the driving speed of the compressor may be lowered at night and. As a result, operation noise and power consumption of the refrigerator can be reduced.

Further, the controller 130 senses opening of the door of the refrigerator (at S241), receives the ambient light brightness transmitted from the optical sensing unit 110 when opening of the door is sensed (at S242), classifies the brightness (at S243), determines an illumination intensity control signal (at S250), and transmits the illumination intensity control signal to the adjustment unit 150 so that the adjustment unit 150 adjusts the illumination intensity (at S260). These Operations in accordance with this embodiment are the same as those in accordance with the former embodiment and a detailed description thereof will thus be omitted.

As described above, in accordance with this embodiment of the present invention, ambient light brightness proximate to the refrigerator is measured and the illumination intensity of the inside lamps is adjusted accordingly, thus reducing glare to a user even at night. Also, the driving speed of the compressor is lowered if low brightness is sensed (e.g., in the night), thus reducing operation noise and power consumption.

In accordance with embodiments of the present invention, an ambient light brightness proximate to a refrigerator is measured and the illumination intensity of inside lamps is adjusted based on the measured brightness, thus reducing glare to a user when the user opens the refrigerator.

Further, the ambient light brightness proximate to a refrigerator and a closed state time of a refrigerator door are measured and the driving speed of a compressor is adjusted accordingly, thus reducing driving noise of the compressor at night and reducing power consumption.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. An apparatus for controlling a refrigerator, the apparatus comprising:
an optical sensing unit configured to sense an ambient light brightness proximate to the refrigerator;
a controller configured to generate an illumination intensity control signal; and
an adjustment unit configured to adjust an illumination intensity inside the refrigerator responsive to the illumination intensity control signal.

2. The apparatus according to claim 1, wherein the controller is further configured to generate a speed control signal based on the ambient light brightness, and wherein the adjustment unit is further configured to adjust the speed of a compressor of the refrigerator responsive to the speed control signal.

3. The apparatus according to claim 3, wherein the speed control signal is generated further based on a closed state time of a refrigerator door.

4. The apparatus according to claim 1, wherein the controller is further configured to: sense opening and closing of the door of the refrigerator; and determine a closed state time of the door, and wherein the ambient light brightness is sensed by the optical sensing unit at a time when the controller senses an opening of the door.

5. The apparatus according to claim 1, wherein the ambient light brightness is constrained to one of a plurality of predetermined categories that are defined by a set of predetermined boundary values, and wherein each predetermined category corresponds to a respective illumination intensity control signal.

6. The apparatus according to claim 5, wherein the plurality of predetermined categories comprise a power-saving category.

7. The apparatus according to claim 1, wherein:
the illumination intensity of the refrigerator is provided by a plurality of lamps installed inside the refrigerator; and
the adjustment unit is further configured to adjust the illumination intensity by selectively activating the lamps and/or controlling brightness of the lamps based on the illumination intensity control signal.

8. The apparatus according to claim 4, wherein the adjustment unit is further configured to, responsive to a signal indicating that the door opens, gradually increase the illumination intensity from a predetermined starting value to a value that is determined based on the illumination intensity control signal.

9. The apparatus according to claim 3, wherein, if the closed state time of the door exceeds a predetermined power-saving time and the ambient light brightness is classified into a predetermined power-saving category, the controller is configured to determine a speed control signal to drive the compressor at a power-saving speed lower than a normal speed.

10. A method of controlling a refrigerator, the method comprising:
sensing an ambient light brightness proximate to the refrigerator;
determining a closed state time of a door of the refrigerator;
determining a speed control signal based on the ambient light brightness and the closed state time;
adjusting the speed of a compressor based on the speed control signal;
determining an illumination intensity control signal to control an illumination intensity inside the refrigerator based on the ambient light brightness; and
adjusting the illumination intensity based on the illumination intensity control signal.

11. The method according to claim 10 further comprising classifying the ambient light brightness in one of a plurality of predetermined categories, each predetermined category corresponding to a respective illumination intensity control signal.

12. The method according to claim 11, wherein the respective illumination intensity control signal is associated with a predetermined illumination intensity.

13. The method according to claim 10, wherein the ambient light brightness is sensed simultaneously with sensing an opening of the door.

14. The method according to claim 10, wherein:
the illumination intensity inside the refrigerator is provided by a plurality of lamps installed inside the refrigerator; and
the illumination intensity is adjusted by selectively turning on the lamps and/or controlling brightness of the lamps based on the illumination intensity control signal.

15. The method according to claim 11, wherein, the illumination intensity is adjusted by gradually increasing from a predetermined starting value to a value is determined value based on the illumination intensity control signal when the door is opened.

16. The method according to claim 10, wherein the adjusting the speed comprises, if the closed state time of the door exceeds a predetermined power-saving time and the ambient light brightness is classified into a predetermined power-saving category, driving the compressor at a power-saving speed lower than a predetermined normal speed.

17. A refrigerator comprising:
an optical sensing unit configured to sense an ambient light brightness proximate to the refrigerator;
a light source disposed inside the refrigerator;
a controller coupled to the optical sensing unit and the light source and configured to generate an illumination intensity control signal based on the ambient light brightness; and
an adjustment unit configured to adjust an illumination intensity of the light source based on the illumination intensity control signal.

18. The refrigerator according to claim 17 further comprising:
a compressor,
wherein the controller is further configured to generate a speed control signal based on the ambient light brightness, and wherein the adjustment unit is further configured to adjust a speed of the compressor based on the speed control signal.
